(19) United States
(12) Patent Application Publication
(10) Pub. No.: US 2022/0240603 A1
(43) Pub. Date: Aug. 4, 2022

(54) FABRIC MATERIAL THAT IS RESISTANT TO FLASH FIRES AND ELECTRICAL ARC FLASHES

(71) Applicant: BURLINGTON INDUSTRIES LLC, Greensboro, NC (US)

(72) Inventors: Brent Smith, Greensboro, NC (US); Tom F. Aubrey, Raeford, NC (US); William J. Dilanni, Kernersville, NC (US)

(21) Appl. No.: 17/589,989

(22) Filed: Feb. 1, 2022

Related U.S. Application Data
(60) Provisional application No. 63/144,634, filed on Feb. 2, 2021.

(51) Int. Cl. A41D 13/02; D03D 15/513; D03D 1/00; A41D 31/08; A62B 17/00

(52) U.S. Cl. CPC A41D 13/02; D03D 15/513; D03D 1/0058; D10B 2201/02; A62B 17/003; D10B 2331/021; A41D 31/08

(57) ABSTRACT

Fabrics and garments are disclosed that have dual protection against flash fires and electrical arc flashes. The fabrics can be made from spun yarns containing an intimate blend of fibers. The fibers contained in each yarn can include modacrylic fibers, natural cellulose fibers, and inherently flame resistant fibers.

### RELATED APPLICATIONS

The present application is based on and claims priority to U.S. Provisional Patent Application Ser. No. 63/144,634 filed on Feb. 2, 2021, which is incorporated herein by reference.

### BACKGROUND

Workers in many industrial settings and in various other occupations can be exposed to hazardous and life threating situations. For example, some workers operate in environments where there is a possibility that they will be exposed to flash fires or electrical arc flashes. For example, workers in many chemical factories face the risk of exposure to chemical flash fires. These flash fires can occur quickly and without warning.

In addition to flash fires, many workers can also be exposed to electrical arc flashes. For example, almost every industrial or manufacturing facility employs electricians to make changes or modify the existing electrical system, to make repairs and/or to change out electrical components. During these operations and procedures, the workers face inherent dangers in working with the electrical lines and the power supply.

To avoid being injured while working in the environments as described above, workers and other personnel should be provided protective apparel that is capable of protecting the worker against the hazards that they may face, including electrical arcs, open flames, and fires. These protective garments can take various forms including full body suits, pants, shirts, aprons, gloves, and the like. Ideally, the protective garment should possess life-saving properties for protecting the wearer should any accidental exposure occur. For example, garments designed to protect workers from flash fires should be made from materials that do not ignite when contacted with an open flame and provide a thermal barrier for the user. Similarly, protective garments designed to protect workers from arc flashes should be capable of being exposed to the arc flash without igniting or allowing the arc flash to propagate through the material.

In the past, various different fabrics have been proposed for producing garments and apparel that will protect workers from flash fires, electrical arc flashes, and the like. Most conventional fabrics, for instance, are very heavy and thick, essentially relying on having enough fabric material between the worker and the hazardous condition to prevent injury. Although capable of protecting workers, these fabrics can cause other problems. For instance, the fabrics add a significant amount of weight to the wearer and typically do not have very good moisture management properties. Thus, workers can become stressed and undergo physical fatigue when wearing garments or apparel made from the fabric.

In the past, those skilled in the art have attempted to produce lighter fabrics that provide protection against flash fires and electrical arc flashes. In constructing the lighter fabrics, however, those skilled in the art have taught against the use of cotton fibers. For instance, those skilled in the art have suggested that the inclusion of cotton fibers creates durability problems and unacceptable wear life.

In view of the above, a need currently exists for an improved fabric that is resistant to flash fires and/or electrical arc flashes that not only offers significant protection to the wearer but is also dimensionally stable. A need also exists for a lightweight fabric that can provide dual protection against both flash fires and electrical arc flashes and that also contains natural cellulose fibers, such as cotton fibers for improving comfort. A need also exists for apparel and garments made from a fabric as described above.

### SUMMARY

In general, the present disclosure is directed to a fabric made from a blend of fibers that can provide protection against flash fires and/or electrical arc flashes while remaining relatively lightweight. Of particular advantage, the fabric can be made containing natural cellulose fibers, such as cotton fibers which not only provide protection to the wearer but also greatly improve comfort and wearability, especially in industrial environments that are not temperature controlled. In one aspect, the fabric can be made from yarns that are the same or substantially the same in both the warp and fill directions providing the fabric with a great balance of physical properties in both directions and dimensional stability. The fabric of the present disclosure can be used to make all different types of garments and apparel.

In one embodiment, for instance, the present disclosure is directed to a garment that is resistant to flash fires and/or electrical arc flashes. The garment includes a fabric shaped to cover at least a portion of a wearer's body. The fabric comprises a woven fabric made from a plurality of yarns. The fabric comprises warp yarns and fill yarns. The warp yarns and fill yarns comprise a fiber blended yarn. The fiber blended yarn comprises a blend of fibers including modacrylic fibers in an amount of from about 35% to about 65% by weight, natural cellulose fibers, such as cotton fibers, in an amount of from about 15% to about 35% by weight, and inherently flame resistant fibers in an amount of from about 15% to about 40% by weight. Alternatively, the fiber blended yarn comprises a blend of fibers including modacrylic fibers in an amount of from about 35% to about 65% by weight, natural cellulose fibers, such as cotton fibers, in an amount of from about 10% to about 30% by weight, and inherently flame resistant fibers in an amount of from about 20% to about 45% by weight.

In one aspect, the yarns contained within the woven fabric are made from an intimate blend of the modacrylic fibers, the natural cellulose fibers, and the inherently flame resistant fibers. In one aspect, the yarns contain the modacrylic fibers in an amount of from about 42% to about 58% by weight; cotton fibers in an amount of from about 22% to about 28% by weight, and inherently flame resistant fibers, particularly aramid fibers, in an amount of from about 22% to about 28% by weight. The inherently flame resistant fibers, for instance, can be para-aramid fibers, meta-aramid fibers, or mixtures thereof.

The woven fabric made in accordance with the present disclosure can generally have a very light weight, especially in relation to the amount of protection the fabric provides. The basis weight of the fabric, for instance, can be less than about 7.5 osy, such as less than about 7 osy, such as less than about 6.5 osy, such as less than about 6.0 osy. In one aspect, the basis weight of the fabric can be from about 4.7 osy to about 6.3 osy. The fabric can made exclusively from the fiber blended yarns. In one aspect, the fabric comprises from about 70 yarns per inch to about 110 yarns per inch in the warp direction and about 45 yarns per inch to about 85 yarns per inch in the fill direction.

In one aspect, the fiber blended yarn as described above extends in both the warp direction and the fill direction and comprises at least about 85% by weight of the fabric. For instance, the fiber blended yarn can comprise greater than about 90% by weight of the fabric, such as greater than about 95% of the weight of the fabric. In one aspect, the woven fabric is made entirely from the fiber blended yarn or includes the fiber blended yarn in combination with from about 0.5% to about 2.5% of antistatic yarns.

The woven fabric can have any suitable weave, such as a twill weave. In one aspect, the woven fabric has a 2×1 twill weave. The inherently flame resistant fibers and the modacrylic fibers contained in the fabric can be solution dyed, while the natural cellulosic fibers can be yarn dyed or fabric dyed to match the other fibers. In one aspect, the woven fabric contains no synthetic cellulose fibers.

The present disclosure is also directed to the fabric material as described above used to produce the garment. When tested according to ASTM Test D6413, for instance, the fabric material can display a char length of less than about 4 inches in the warp direction and less than about 3 inches in the weft or fill direction before being laundered. When tested for arc flash protection according to ASTM Test F1959, on the other hand, the fabric material can display a result of greater than about 8.3 cal/cm² s, such as greater than about 8.5 cal/cm² s.

Garments made in accordance with the present disclosure include shirts, overalls, trousers, aprons, and the like.

The present disclosure is also directed to a fabric material as described above that is used to construct the garment.

Garments and fabric materials made according to the present disclosure have an excellent balance of properties. In one aspect, the fabric material can be both resistant to flash fires and electrical arc flashes.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is one embodiment of a garment made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a fabric material and apparel made from the fabric material that are resistant to flash fires and/or arc flashes. The fabric of the present disclosure generally comprises yarns made from a fiber blend that includes modacrylic fibers and inherently flame resistant fibers combined with natural cellulose fibers, such as cotton fibers. The fiber blended fabric can be incorporated into all different types of protective apparel including shirts, pants, coveralls, coats, aprons, gloves, hoods, and the like.

In one aspect, the fabric of the present disclosure can be designed to protect not only against flash fires but also against electrical arc flash exposure. For example, many workers operate in environments where possible exposure to flash fires, such as chemical fires, and possible exposure to electrical arc flashes are both present. Alternatively, workers may move in between manufacturing areas and thus can be exposed to both of the above hazards. The fabric of the present disclosure can provide dual hazard protection economically and at relatively low basis weights.

In addition to providing dual protection against flash fires and electrical arc flashes, the fabric of the present disclosure offers many benefits and advantages. More particularly, the fabric is made from yarns that each contain an intimate blend of fibers including modacrylic fibers, inherently flame resistant fibers, and natural cellulose fibers, such as cotton fibers. The yarns made from the intimate blend have been found to be well suited for use in both the warp direction and the fill direction of a woven fabric. By having similar yarns in the warp and fill directions, fabrics made according to the present disclosure have an excellent balance of properties. For example, the fabric can have comparable physical properties, such as strength properties, in both directions which provide the fabric with dimensional stability.

As described above, the fabric material of the present disclosure contains natural cellulose fibers, such as cotton fibers. The use of natural cellulose fibers can provide various advantages and benefits, especially in relation to fabrics that contain synthetic fibers, such as regenerated cellulose fibers (e.g. rayon fibers). Natural cellulose fibers, such as cotton fibers, for instance, can increase comfort, and breathability. The natural cellulose fibers can also lead to a fabric material that has an overall improved aesthetic appearance. Natural cellulose fibers are also considered a renewable resource that makes the product more sustainable and better for the environment. Of particular advantage, the use of natural cellulose fibers, such as cotton fibers, greatly enhances the wet strength of the fabric, especially in relation to fabrics that contain synthetic cellulose fibers, such as rayon or lyocell fibers.

The fabric material of the present disclosure also contains substantial amounts of natural cellulose fibers while still displaying significant levels of protection against flash fires and electrical arc flashes. For instance, the fabric material of the present disclosure can maintain government mandated safety performance properties while providing improved economics, quality, aesthetics and comfort relative to other fabrics made in the past. For example, fabrics materials made according to the present discourse can meet all of the requirements of the National Fire Protection Association (NFPA) Standard 70E that relates to chemical flash fire protection and protective apparel for electrical arc hazards.

As described above, the fabric of the present disclosure is formed from spun yarns that contain a particular blend of fibers. More particularly, the blend of fibers include modacrylic fibers, natural cellulose fibers, and inherently flame resistant fibers, such as aramid fibers. The spun yarns incorporated into the fabric can be single spun yarns or can be plied yarns, such as two ply yarns. Alternatively, the fabric can contain both single spun yarns and plied yarns. In one aspect, the fabric contains plied yarns in at least one direction, such as in the warp direction, the fill direction or in both directions.

The size of the spun yarns can vary depending upon the particular application and the desired result. For example, the size of the spun yarns can depend upon the desired overall fabric weight of the fabric, the type of garment being formed, and the like. In one aspect, when using single yarns, the yarn size can be 12/1, 14/1, 16/1, 18/1, 20/1, 22/1, 24/1, 26/1, 28/1, 30/1, 32/1, 34/1, 36/1, 38/1, and/or 40/1 including all intervening sizes therebetween and all ranges therebetween. When using plied yarns, on the other hand, the size of the yarns can be 20/2, 22/2, 24/2, 26/2, 28/2, 30/2, 34/2, 36/2, 38/2, 40/2, 44/2, 48/2, 52/2, 56/2, 60/2, 64/2, 68/2, 72/2, or 76/2 including all intervening sizes therebetween and all ranges therebetween. The above sizes are based on a cotton count.

The spun yarns produced according to the present disclosure containing modacrylic fibers, natural cellulose fibers, and inherently flame resistant fibers, can extend only in the warp direction, only in the fill direction, or can extend in both the warp direction and the fill direction. Improved physical properties may be realized by having yarns made according to the present disclosure extend in both the warp direction and the fill direction. In fact, in one embodiment, greater than 90% by weight, such as greater than about 95% by weight, such as 100% by weight of the fabric can be formed from spun yarns made in accordance with the present disclosure. The spun yarns contained in the fabric can all be identical and can be made from the exact same intimate blend of fibers. Alternatively, different spun yarns can be incorporated into the fabric that are all made with different ratios or amounts of the modacrylic fibers, natural cellulose fibers, and inherently flame resistant fibers.

Modacrylic fibers can be present in the spun yarns and in the fabric generally in an amount from about 35% by weight to about 65% by weight, including all increments of 1% by weight between. For example, the modacrylic fibers can be present in the spun yarns in an amount greater than about 38% by weight, such as in an amount greater than about 40% by weight, such as in an amount greater than about 42% by weight, such as in an amount greater than about 45% by weight, such as in an amount greater than about 48% by weight. The modacrylic fibers are generally contained in the spun yarns in an amount less than about 63% by weight, such as in an amount less than about 60% by weight, such as in an amount less than about 58% by weight, such as in an amount less than about 55% by weight, such as in an amount less than about 53% by weight. The modacrylic fibers incorporated into the fabric material can serve several different functions. For example, modacrylic fibers can provide resistance to flash fires and electric arc flashes while having a relatively low density. The lower density translates into a protective fabric having a lighter basis weight. In addition, modacrylic fibers have good dimensional stability. Modacrylic fibers are also soft, strong and are resistant to chemicals and solvents. Thus, modacrylic fibers are particularly well suited for use in fabric materials that may be exposed to chemical flash fires.

In addition to modacrylic fibers, the yarns and fabric material of the present disclosure also contain natural cellulose fibers. As described above, the natural cellulose fibers provide various advantages, especially in relation to synthetic cellulosic fibers. The cellulose fibers, for instance, improve comfort and breathability. Of particular advantage, the natural cellulose fibers can increase the wet strength of the fabric material, which is particularly important in industrial settings. Overall, the addition of natural cellulose fibers, such as cotton fibers, improve quality, aesthetics and comfort. In accordance with the present disclosure, significant amounts of natural cellulose fibers are incorporated into the fabric material and blended with other fibers that results in a fabric material that meets government safety standards with respect to flash fires and electrical arc flashes. In general, the natural cellulose fibers, such as cotton fibers, can be present in the spun yarns and in the fabric material generally in an amount of from about 15% by weight to about 35% by weight or from about 10% to about 30% by weight, including all increments of 1% by weight therebetween. For example, natural cellulose fibers can be present in the spun yarns in an amount greater than about 12% by weight, such as in an amount greater than about 15% by weight, such as in an amount greater than about 17% by weight, such as in an amount greater than about 20% by weight, such as in an amount greater than about 22% by weight, and generally in an amount less than about 33% by weight, such as in an amount less than about 30% by weight, such as in an amount less than about 28% by weight, such as in an amount less than about 25% by weight, such as in an amount less than about 23% by weight.

The modacrylic fibers and natural cellulose fibers are also combined with inherently flame resistant fibers in producing the spun yarns. The inherently flame resistant fibers can include, for instance, aramid fibers such as para-aramid fibers and/or meta-aramid fibers. Other inherently flame resistant fibers include polybenzimidazole (FBI) fibers or poly(p-phenylene-2,6-bezobisoxazole) (PBO) fibers and the like. In one embodiment, for instance, the fabric material only contains aramid fibers such as para-aramid fibers alone or in combination with meta-aramid fibers. In still another embodiment, the fabric material contains only meta-aramid fibers. In still another embodiment, the fabric material contains aramid fibers in combination with PBI fibers. The inherently flame resistant fibers can be present in the spun yarns and in the fabric material generally in an amount from about 15% by weight to about 40% by weight, such as in an amount of from about 20% by weight to about 45% by weight including all increments of 1% therebetween. For example, the inherently flame resistant fibers can be present in the spun yarns in an amount greater than about 17% by weight, such as in an amount greater than about 20% by weight, such as in an amount greater than about 22% by weight, such as in an amount greater than about 25% by weight, such as in an amount greater than about 27% by weight, and generally in an amount less than about 40% by weight, such as in an amount less than about 35% by weight, such as in an amount less than about 33% by weight, such as in an amount less than about 30% by weight, such as in an amount less than about 28% by weight.

As described above, the fabric material of the present disclosure can be made exclusively from the spun yarns as described above. In one aspect, antistatic fibers and/or yarns can also be incorporated into the fabric. The antistatic fibers or yarns, for instance, can be contained in the fabric material generally in an amount less than about 3% by weight, such as in an amount less than about 2% by weight, and generally in an amount greater than about 0.5% by weight. The antistatic fibers can contain carbon.

In one aspect, the spun yarns made according to the present disclosure include an intimate fiber blend containing modacrylic fibers in an amount of from about 42% to about 58% by weight, natural cellulose fibers, particularly cotton fibers, in an amount of from about 22% to about 28% by weight, and inherently flame resistant fibers, particularly meta-aramid fibers alone or in combination with para-aramid fibers, in an amount of from about 22% by weight to about 28% by weight.

In another aspect, the spun yarns made according to the present disclosure include an intimate fiber blend containing modacrylic fibers in an amount of from about 42% to about 58% by weight, natural cellulose fibers, particularly cotton fibers, in an amount of from about 17% to about 26% by weight, and inherently flame resistant fibers, particularly meta-aramid fibers alone or in combination with para-aramid fibers, in an amount of from about 27% by weight to about 33% by weight.

In one aspect, spun yarns made in accordance with the present disclosure can account for about 50% to about 100% of the warp yarns used to produce the fabric, such as from about 70% to about 100%, such as from about 70% to about 98%, such as from about 80% to about 90%. Similarly, the spun yarns made in accordance with the present disclosure can account for from about 50% to about 100% of the fill yarns, such as from about 60% to about 100% of the fill yarns, such as from about 70% to about 100% of the fill yarns, such as from about 70% to about 98% of the fill yarns.

When producing a woven fabric in accordance with the present disclosure, the fabric can have any suitable weave. For instance, the fabric can have a plain weave, a twill weave, or a rip stop weave. In one embodiment, the fabric can also be made with a herringbone weave. Twill weaves that can be used include 1 by 2 twill weaves, 1 by 3 twill weaves, 1 by 4 twill weaves, 2 by 1 twill weaves, and the like. Alternatively, the fabric can have a rip stop weave.

The yarn density of fabrics made according to the present disclosure can vary depending upon the size and type of yarns used, the desired basis weight of the fabric, and other various factors.

In one aspect, the fabric can have greater than about 50 ends per inch, such as greater than about 70 ends per inch, such as greater than about 75 ends per inch, such as greater than about 85 ends per inch and generally less than about 100 end per inch, such as less than about 95 ends per inch, such as less than about 90 ends per inch. The fabric can have generally greater than about 30 picks per inch, such as greater than about 45 picks per inch, such as greater than about 50 picks per inch, such as greater than about 55 picks per inch, such as greater than about 60 picks per inch, and generally less than about 90 picks per inch, such as less than about 70 picks per inch, such as less than about 65 picks per inch, such as less than about 60 picks per inch.

In general, the fabric can have a basis weight of less than about 7.5 osy, such as less than about 7.3 osy, such as less than about 7 osy, such as less than about 6.8 osy, such as less than about 6.5 osy, such as less than about 6.3 osy, such as less than 6 osy, such as less than about 5.9 osy. The basis weight is generally greater than about 4 osy, such as greater than about 4.3 osy, such as greater than about 4.5 osy, such as greater than about 4.7 osy. In one particular aspect, the basis weight of the fabric can be from about 4.7 osy to about 6.3 osy.

The fabrics constructed in accordance with the present disclosure can be used to construct numerous different types of products for use in various applications. In one embodiment, for instance, the fabrics can be used to produce apparel or garments for providing protection against hazards, such as flash fires or electric arc flashes. Due to the combination of comfort, durability and protection, fabrics of the present disclosure are particularly well suited for producing protective apparel to be worn by workers in various environments, such as in industrial environments and manufacturing facilities. Garments or apparel made in accordance with the present disclosure can include shirts, pants, bib overalls, one-piece bodysuits, socks and other leg wear, gloves, scarves, hats, hoods, aprons, and the like

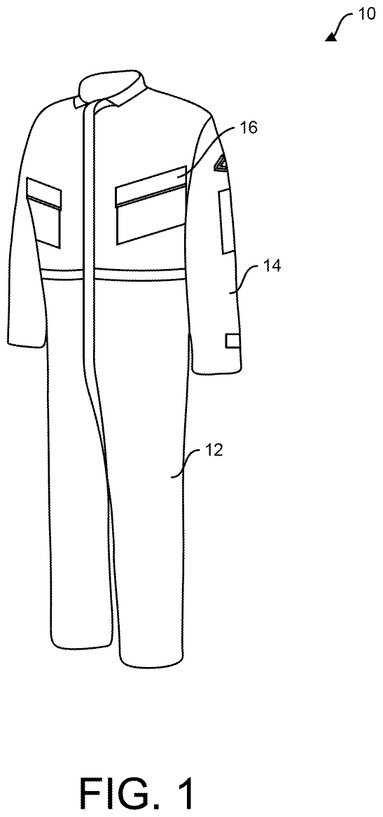

For instance, referring to FIG. 1, one example of a coverall 10 made in accordance with the present disclosure is shown. The coverall 10 includes pants or leg coverings 12 and sleeves 14 all integrated into a single garment. The garments can include various pockets but also include flaps 16 for covering the pockets.

It should be understood that the coveralls 10 as shown in FIG. 1 is merely one embodiment of a garment made in accordance with the present disclosure. In other embodiments, the garment can include separate pants or trousers that are worn with a shirt all made from the same fabric of the present disclosure.

The fabric of the present disclosure and/or apparel or garments made from the fabric can be dyed any desired color. For example, in one aspect, fabrics made according to the present disclosure can be piece dyed when producing garments. During piece dying, the woven fabric is fed through a dying process. Of particular advantage, fabrics can be piece dyed according to the present disclosure and have a uniform and consistent shade of color even though the fabric contains different types of fibers.

Alternatively, the yarns can first be dyed and then woven to form the fabric. For instance, fabrics can be made according to the present disclosure containing yarns that have been packaged dyed, which includes doped dyed yarns.

In still another aspect, the fibers incorporated into the fabric of the present disclosure can first be dyed prior to forming the yarns. In one aspect, for instance, the modacrylic fibers and/or the inherently flame resistant fibers can be solution dyed or dope dyed. In particular, one or more coloring agents or dyes can be added at the time of extrusion of the fiber, which enhances the durability of the fabric color.

In addition, all of the above dying techniques can be combined together in forming fabrics. In one embodiment, the spun yarns can include fibers that have been solution dyed and the woven fabric can be later piece dyed.

In one aspect, the fabric or garment can be dyed to shades that have high visibility in accordance with The American National Standard for High-Visibility Safety Apparel (ANSI/ISEA 107-2020). For example, the fabric can display a background color of fluorescent yellow-green, fluorescent orange-red or fluorescent red in accordance with the ANSI 107 standard. The colors can also be wash resistant and maintain the ANSI 107 standard after 5 laundry cycles or after 10 laundry cycles.

Fabrics made according to the present disclosure can have numerous beneficial properties and characteristics that provide protection against hazards, such as flash fires and/or electrical arc flashes, but also provide comfort to the wearer. Fabrics made according to the present disclosure, for instant, can be durable, be resistant to pilling and be abrasion resistant all at relatively low basis weights for fabrics designed to protect wearers from flash fires. Of particular advantage, fabrics made according to the present disclosure also have excellent dimensional stability and retain their mechanical properties even when wet.

Regarding protection against various hazards, the fabric material of the present disclosure can display excellent flame protection. For example, when tested according to ASTM Test D6413 (flame performance), fabric materials according to the present disclosure display a char length before laundering of less than about 4.5 inches, such as less than about 4 inches, such as less than about 3.5 inches in the warp direction. The fabric material may display a char length of less than about 3.5 inches, such as less than about 3 inches, such as less than about 2.7 inches in the fill direction. When laundered 100 laundry cycles, the fabric material still displays a char length of less than 4 inches in the warp direction and less than 3.2 inches in the fill direction.

Fabric materials according to the present disclosure have also been tested for mannequin burn performance according to ASTM Test F1930. The mannequin burn performance average predicted second degree burn to be less than approximately 30%. In addition, the fabric can display a thermal shrinkage at 260° C. for 5 mins of less than 2% in both the warp and fill directions. When tested against electrical arc flashes according to ASTM Test F1959 (ASTM Test 1959/F1959 M-14e1), the fabric or garments made from the fabric can demonstrate a rating of greater than about 8 cal/cm², such as greater than about 8.3 cal/cm², such as greater than about 8.5 cal/cm², and generally less than about 10 cal/cm². Achieving a rating of greater than 8 cal/cm² indicates that the fabric also meets the requirements of NFPA70E Class 2. Various standardized tests and protocols are also described in U.S. Patent Publication 2019/0242038, which is incorporated herein by reference. Of particular advantage, fabrics made according to the present disclosure can have the above properties while still having a basis weight of less than about 7.5 osy, such as less than about 6.5 osy, such as less than 6 osy.

When tested for dimensional stability according to Test AATCC 135, (home launder), the fabric can display a stability value of less than about 5%, such as less than about 4%, such as less than about 3.8%, such as less than about 3.5% in the warp direction. In the fill direction, the dimensional stability value can also be less than about 5%, such as less than about 4%, such as less than about 3%, such as less than about 2.8%, such as less than about 2%.

All of the above characteristics, for instance, can be demonstrated by a 6 osy fabric made from spun yarns containing 50% by weight modacrylic fibers, 25% or 20% by weight natural cotton fibers, and 25% or 30% by weight aramid fibers comprising 20% or 25% by weight meta-aramid fibers and 5% para-aramid fibers. The yarns had a size of 36/2 and were vortex spun.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A garment for producing protection against flash fires and electrical arc flashes comprising;
a fabric shaped to cover at least a portion of a wearer's body, the fabric comprising a woven fabric made from a plurality of yarns, the fabric comprising warp yarns and fill yarns, the warp yarns and fill yarns comprising a fiber blended yarn, the fiber blended yarn comprising a blend of fibers including:
modacrylic fibers in an amount from about 35% to about 65% by weight;
natural cellulose fibers in an amount from about 15% to about 35% by weight; and
inherently flame resistant fibers in an amount from about 15% to about 40% by weight.

2. A garment as defined in claim 1, wherein the yarns contained within the woven fabric are made from an intimate blend of the modacrylic fibers, the natural cellulose fibers, and the inherently flame resistant fibers.

3. A garment as defined in claim 1, wherein the woven fabric has a twill weave or a rip stop weave.

4. A garment as defined in claim 1, wherein the natural cellulose fiber comprise cotton fibers.

5. A garment as defined in claim 1, wherein the modacrylic fibers are present in the fiber blended yarn in an amount from about 42% by weight to about 58% by weight, the natural cellulose fibers being present in the fiber blended yarn in an amount from about 17% by weight to about 23% by weight, and the inherently flame resistant fibers being present in the fiber blended yarn in an amount from about 27% by weight to about 33% by weight.

6. A garment as defined in claim 1, wherein the inherently flame resistant fibers comprise para-aramid fibers, meta-aramid fibers, or mixtures thereof.

7. A garment as defined in claim 1, wherein the woven fabric has a basis weight of from about 4.7 osy to about 6.3 osy.

8. A garment as defined in claim 1, wherein the fiber blended yarn comprises greater than about 85% by weight of the woven fabric.

9. A garment as defined in claim 1, wherein the woven fabric comprises about 70 yarns per inch to about 110 yarns per inch in the warp direction and from about 45 yarns per inch to about 85 yarns per inch in the fill direction.

10. A garment as defined in claim 1, wherein the garment comprises a shirt, overalls, trousers, or an apron.

11. A garment as defined in claim 1, wherein the woven fabric has a 2×1 twill weave or a rip stop weave.

12. A garment as defined in claim 1, wherein the modacrylic fibers and the inherently flame resistant fibers have been solution dyed.

13. A garment as defined in claim 1, wherein the garment displays arc flash protection of greater than about 8.3 cal/cm² when tested according to ASTM F1959.

14. A garment as defined in claim 1, wherein the woven fabric displays a char length of less than about 4 inches in the warp direction and less than about 3 inches in the weft direction when tested according to ASTM Test D6143 before laundering.

15. A garment as defined in claim 1, wherein the woven fabric does not contain any synthetic cellulose fibers.

16. A fabric material for providing protection against flash fires and electrical arc flashes comprising a woven fabric made from a plurality of yarns, the fabric comprising warp yarns and fill yarns, the warp yarns and fill yarns comprising a fiber blended yarn, the fiber blended yarn comprising a blend of fibers including:
modacrylic fibers in an amount from about 35% to about 65% by weight;
natural cellulose fibers in an amount from about 15% to about 35% by weight; and
inherently flame resistant fibers in an amount from about 15% to about 40% by weight.

17. A fabric material as defined in claim 16, wherein the natural cellulose fibers comprise cotton fibers and wherein the inherently flame resistant fibers comprise para-aramid fibers, meta-aramid fibers, or mixtures thereof, and wherein the fabric comprises from about 70 yarns per inch to about 110 yarns per inch in the warp direction and from about 45 yarns per inch to about 85 yarns per inch in the fill direction, the fabric material having a basis weight of less than about 7.5 osy.

18. A fabric material as defined in claim 16, wherein the fiber blended yarn comprises at least about 85% by weight of the fabric material.

19. A fabric material as defined in claim 16, wherein the garment displays arc flash protection of greater than about 8.3 cal/cm² when tested according to ASTM F1959.

20. A fabric material as defined in claim 16, wherein the woven fabric displays a char length of less than about 4 inches in the warp direction and less than about 3 inches in the weft direction when tested according to ASTM Test D6143 before laundering
